(19) United States
(12) Patent Application Publication
(10) Pub. No.: US 2014/0006315 A1
(43) Pub. Date: Jan. 2, 2014

(54) METHOD OF MARKETING OREGANO CAPSULES CONTAINING THYMOQUINONE

(71) Applicants: Stèphane Etheve, Basel (CH); Kevin PRUDENCE, Basel (CH); Loni SCHWEIKERT, Basel (CH); Aniko Szepes, Basel (CH)

(72) Inventors: Stèphane Etheve, Basel (CH); Kevin PRUDENCE, Basel (CH); Loni SCHWEIKERT, Basel (CH); Aniko Szepes, Basel (CH)

(21) Appl. No.: 13/539,575

(22) Filed: Jul. 2, 2012

(51) Int. Cl. G06Q 90/00

(52) U.S. Cl. CPC G06Q 90/00
USPC 705/500

(57) ABSTRACT

This invention relates to a method of marketing capsule formulations for pharmaceutical, nutraceuticals or food supplements which contain oregano oil containing thymoquinone (THQ) as an active ingredient at a concentration of least 2 weight % and which can be stored at room temperature. The capsules have a hydroxypropylmethylcellulose (HPMC) shell and may contain carvacrol (CRV) as an additional active ingredient, either in synthetic form, or as part of a plant extract. Optionally, the capsules may contain a viscosity agent. The method includes the steps of advising a potential consumer of the benefits of THQ, and optionally CRV and providing a kit containing these capsules.

### BRIEF DESCRIPTION OF THE INVENTION

This invention relates to a method of marketing capsule formulations for pharmaceutical, nutraceuticals or food supplements which contain oregano oil comprising thymoquinone (THQ) as an active ingredient at a concentration of least 2 weight % and which can be stored at room temperature. The capsules have a hydroxypropylmethylcellulose (HPMC) shell and may also comprise carvacrol (CRV) as an additional active ingredient, either in synthetic form, or as part of a plant extract. Optionally, the capsules may contain a viscosity agent. The method includes the steps of advising a potential consumer of the benefits of THQ, and optionally CRV and providing a kit containing these capsules.

### BACKGROUND OF THE INVENTION

Oregano extract contains a number active ingredients, including carvacrol (CRV) and thymoquinone (THQ). While carvacrol is a relatively stable molecule in various formulations, THQ is not, and when oragano extract is formulated conventionally, the THQ degrades quickly. Thus, commercially available capsules containing oregano extract contain less than 1 wt % THQ, while their CRV content may be 50 wt % or even higher.

THQ has been found to be one of the active ingredients which may contribute to the various benefits described for oregano extract. Oregano extract active ingredients can aid in mental processing, as described in WO 08/017484 (DSM IP Assets, B.V), which is hereby incorporated by reference.

WO 09/150179 (DSM IP Assets, B.V.) uses a polyunsaturated fatty acids (PUFAs) and their ethyl esters (PUFA EEs) to stabilize oregano extract which can be used in various capsules. The PUFAs/PUFA EEs prevent a waxy precipitation of the extract, and thus stabilizes the extract, but the PUFAs do not protect the THQ from degredation.

WO 10/094761 (DSM IP ASSETS, B.V.) describes a capsule (LiCaps) containing oregano extract, tricylglycerol (DURKEX 200), and phosphatidylcholine. These capsules were stored at 4° C. to prevent degredation of the THQ, and thus are not suitable for storage at room temperature.

As THQ is only present in limited amounts at best (i.e. less than 1 wt %), in conventional oregano capsules, consumers of currently available oregano extract capsules are not obtaining its benefits. Storage of capsules in a refrigerated environment is inconvenient, and may add to costs during shipping. There is also the problem that exposure to prolonger higher temperatures degrades the THQ. Thus, it would be desirable to be able to market an oregano capsule containing an effective amount of THQ, in a convenient room-temperature stable capsule and to educate the consumer of the benefits of the complete oregano extract.

### DETAILED DESCRIPTION OF THE INVENTION

It has been found, in accordance with this invention, that the stability of THQ in an oregano extract can be maintained in a capsule comprising:
a) shell selected from the group consisting of: hydroxypropylmethylcellulose (HPMC), pullulan, and gelatin;
b) a fill composition comprising oregano extract comprising at least 2 weight % thymoquinone (THQ), preferably from 2-8 weight % thymoquinone;
c) a diluent selected from the group consisting of: middle chain triglycerides, glycerol, edible vegetable waxes; plant oils (for example: olive oil, palm oils, sunflower oils, maize/corn oil, soybean oil, sesame oil, or rice bran oil), and mixtures thereof; and
d) a viscosity increasing agent, with the proviso that the viscosity increasing agent is not phosphaditylcholine, and with the further proviso that when the shell is pullulan or gelatin, then the viscosity increasing agent comprises neither phosphatidylcholine nor lecithin.

Therefore, one aspect of this invention is a method of marketing the above capsule comprising
a) providing a kit to a customer, said kit comprising the above capsules, and
b) providing providing informational material to potential consumers, wherein said informational material describes at least one benefit of THQ.

As consumers may not be not aware that THQ and/or the combination of THQ and CRV, (the combination which exists in fresh oregano extract) is beneficial for a number of reasons, including in the areas of cognition and other mind/mood areas, one aspect of this invention is a method of marketing a capsule comprising
providing a kit, wherein the kit comprises a plurality of capsules in a capsule container, wherein each capsule comprises:
a) shell selected from the group consisting of: hydroxypropylmethylcellulose (HPMC), pullulan, and gelatin;
b) a fill composition comprising an oregano extract comprising at least 2 weight % thymoquinone (THQ), preferably from 2-8 weight % thymoquinone;
c) a diluent selected from the group consisting of: middle chain triglycerides, glycerol, edible vegetable waxes; plant oils (for example: olive oil, palm oils, sunflower oils, maize/corn oil, soybean oil, sesame oil, or rice bran oil), and mixtures thereof; and
d) a viscosity increasing agent, with the proviso that the viscosity increasing agent is not phosphaditylcholine, and with the further proviso that when the shell is pullulan or gelatin, then the viscosity increasing agent comprises neither phosphatidylcholine nor lecithin; and
providing informational material which comprises information about the benefits of a capsule containing oregano extract comprising at least 2 weight % thymoquinone.

The capsule may be in a capsule container which may take any conventional form. For example it may be sold in a jar, bottle, tin box, pot, or the like which contains the capsules in a predetermined quantity, such as a 30-day supply, a 60-day supply, a 90-day supply or in whatever quantity which is desired. Additionally and optionally, the capsules may be in a blister pack, wherein each blister contains a predetermined number of capsules, usually a single dose (typically 1-4 capsules). The arrangement of the number of capsules in a blister, the number of blisters on a single blister pack strip, and the number of blister pack strips which are sold in a group may be any convenient amounts.

The informational material may be part of the material used to package the capsules. For example, if the capsules are packaged in a container which may be re-opened and closed, such as a jar, bottle, or pot, then the informational material may be printed on a label which is affixed to the outside of the container. Alternatively and/or additionally, the informational material may be on a separate insert which is placed in a box, envelope, or the like which holds the container. In instances where the capsules are packaged in a blister pack or the like, the informational material may be printed on the blister pack strip, on a receptacle such as a box or envelope containing the blister pack strips, and/or included in a package insert placed inside the box or envelope containing the blister packs.

Alternatively and/or additionally, the informational material need not be physically associated with the kit. For example, the informational material may be in the form of printed leaflets, flyers, advertising placards, or the like which is displayed in the proximity (preferably within one meter) of the kit. The informational material may be in a form which allows the potential consumer to take a printed material (such as a handout, flier, postcard or the like) or may merely impart information. The information may be provided to the customer through conventional marketing methods using a variety of media, such as though mass communication advertising (television/radio advertising, print advertising such as in magazines, internet marketing and advertising such as through web sites, social networking sites, and the like). The important point is that the consumer is informed about at least one benefit of THQ as found in oregano extracts, and/or in combination with CRV.

One important aspect of this invention is that the capsules can be stored at room temperature and the THQ remains present throughout the shelf life of the capsule. In previous oregano extract capsules stored at room temperature, the THQ is quickly degraded, such that if it is present at all in the capsule, it is present only at a significantly reduced amount (i.e. less than 1% by weight). In preferred embodiments, the consumer is informed of the fact that capsules may be stored at room temperature.

### Benefits of THQ

The exact wording of the informational material is not a critical part of the invention, provided that it conveys at least one benefit selected from the following genera of benefits:

a) THQ can mask the taste of CRV
b) THQ can boost mental processes. THQ has been shown to be active by interacting with neurotransmitters
c) THQ can act on mental processes by boosting and/or enhancing brain waves or brain wave activity
d) the capsules contain the completeness of the oregano extract, as they contain THQ
e) the capsules provide a natural renewable source of the oregano extract containing THQ
f) the capsules provide a source of stable THQ that can be maintained at room temperature.
g) oregano is an alternative source of THQ—generally, the only alternative source of THQ is Nigella sativa.

In some embodiments, the information material is provided within packaging for the kit. For example, the informational material may form part of a label for the capsule container. In other examples, the information material may be a package insert, or printed on a box or package which also contains the capsule container.

In preferred embodiments, the THQ is present in combination with other active ingredients, such as carvacrol (CRV). These ingredients may be present in a plant extract.

### BRIEF DESCRIPTION OF THE FIGURES

FIG. 1 is a set of graphs showing the stability of THQ in gelatin capsules during storage.

FIG. 1a is at 25° C./60% relative humidity (RH) and FIG. 1b is at 40° C./75% RH.

FIG. 2 is a set of graphs showing the stability of CARV in gelatin capsules during storage. FIG. 2a is at 25° C./60% RH and FIG. 2b is at 40° C./75% RH

FIG. 3 is a set of graphs showing stability of THQ in HPMC capsules during storage.

FIG. 3a is at 25° C./60% RH and FIG. 3b at 40° C./75% RH

FIG. 4 is a set of graphs showing the stability of CAR in HPMC capsules during storage.

FIG. 4a is at 25° C./60% RH & and FIG. 4b is at 40° C./75% RH.

FIG. 5 is a set of graphs showing the stability of THQ in pullulan capsules during storage.

FIG. 5a is at25° C./60% RH and FIG. 5b is at 40° C./75% RH.

FIG. 6 is a set of graphs showing the stability of CAR in pullulan capsules during storage.

FIG. 6a is at 25° C./60% RH & FIG. 6b is at 40° C./75% RH.

### OREGANO EXTRACT CONTAINING THQ

The oregano extracts may be of any origin from a plant (whole plant or parts thereof) belonging to the genera Origanum such as Origanum vulgare or O. minutiflores and Thymus such as Thymus vulgaris in form of a concentrate of extractable compounds. Further examples of plants from the genus Origanum covered by the term “oregano”, are O. majorana, O. dictamus, O. creticum, O. x majoricum, O. aureum, O. compactus, O. syriaca, O. tytthantum, O. heracleoticum, O. smyrnaeum and O. virens. Further examples of plants from the genus Thymus covered by the term “oregano” are T herbus-barona, T. citriodorus, T. mastichiana, T. pulegioides, T. serpyllum, T. pallasianus and T. praecox. The concentrate may still contain solvents used for the extraction, be free from them or may be transferred to specific carrier materials. The extracts may be obtained in accordance with methods well-known in the art, e.g., by (an) extraction with solvents like methanol, ethanol, ethyl acetate, diethylether, n-hexane, methylenechloride, or with supercritical fluids like carbon dioxide (pure or in mixture with other solvents such as alcohols) or dinitrogen oxide, (b) hydrodistillation for obtaining essential oils or (c) extraction/distillation with hot gases like nitrogen.

Preferably oregano extracts are used that are obtained by an extraction with the use of supercritical carbon dioxide. Such extracts have the advantage that they do not contain any organic solvents, no proteins and no heavy metals. If desired, an extraction with supercritical carbon dioxide is followed by a second supercritical fluid CO2-extraction step to remove waxes and selectively enrich the volatiles.

The oregano extracts or their volatile components can be of natural or synthetic or mixed (viz. partly natural, partly synthetic) origin, i.e., they can, apart from being obtained by extraction of plants and fractionation, be chemically synthesized and, if desired, mixed together in any desired quantities. They can be prepared and used in any desired purities and concentrations, e.g. as solutions containing them in concentrations as low as, e.g., 10% (w/w) or less, or up to nearly 100% (w/w).

Preferred are oregano extracts containing a high proportion of at least one of their volatile components. More preferred are oregano extracts containing at least a total of 70 weight-% of volatile components as mentioned above, based on the total weight of the extract. Completely natural oregano extracts may be fortified with at least one specific volatile component thereof.

Preferred are oregano extracts are oregano extracts which comprise thymoquinone in an amount in the range of from at least 2 weight-% THQ, with higher amounts of THQ generally being preferred. For example, 2-8 weight % is a preferred amount. The upper limit of THQ may be higher than 8 weight %.

Preferred oregano extracts in the context of the present invention are those which also comprises CRV, such as wherein the extract comprises THQ as above, and also: at least 30 weight-% of carvacrol, preferably at least 50 weight-% of carvacrol, more preferably at least 60 weight-% of carvacrol, and most preferably wherein the oregano extract comprises at least 65 weight-% of carvacrol.

### The Capsule Shell

The capsule shell can be selected from the group consisting of HPMC, pullulan and gelatin. However, it has been found in accordance with this invention, that if the capsule shell is either pullulan or gelatin, and the viscosity-increasing agent is phosphatidylcholine or lecithin, then THQ is not stable. Thus, in accordance with this invention, the capsule shell may be:
a) HPMC—may be used with any viscosity-increasing agent
b) Pullulan—with the proviso that the viscosity increasing agent is not phosphatidylcholine or lecithin; or
c) Gelatin with the proviso that the viscosity increasing agent is not phosphatidylcholine or lecithin.

In preferred embodiments the shell is HPMC, and the consumer is informed that the capsule is suitable for those following a Kosher, Halal or vegetarian diet.

### The Diluent

The pure oregano extract should not be filled into capsules without mixing it with compatible excipients, since it can damage capsule integrity in high concentration during storage. Suitable diluents include: middle chain triglycerides, preferably oleic acid, edible vegetable waxes; plant oils (for example: olive oil, palm oils, sunflower orils, maize/corn oil, soybean oil, sesame oil, or rice bran oil). The concentration of diluent may vary depending on the particular oregano extract utilized, and as it is sufficient to ensure that the capsule shell remain intact; this can be determined using known methods. It is preferably present at least 50 w/w %, more preferably at least 50-60 w/w %. In some compositions, it is 58 w/w %.

### The Viscosity Increasing Agent

Viscosity modifiers might be needed to adjust the viscosity of the fill for accurate dosing and filling on high speed equipment. Therefore, they are a preferred component of the capsule fill. As the combination of pullulan and phosphatidylcholine or lecithin adversely affect THQ stability, this combination should not be used. Similarly, the combination of gelatin and phosphatidylcholine or lecithin also adversely affect THQ stability, so this combination should not be used. Known viscosity enhancers include: silicum dioxide, stearic acid, cetostearyl, cetyl and stearyl alcohols, glyceryl behenate, glyceryl palmitostearate, several partially or fully hydrogenated glycerides and fatty acid esthers.

In preferred capsules, the viscosity enhancer is silicum dioxide.

It is also preferred that the capsules be opaque or colored to protect from light degredation.

Capsules according to this invention can be assembled in standard ways. Hard capsules containing liquids or semi-solids have to be filled and sealed sequentially in order to prevent leakage. The two commonly used industrial methods for sealing capsules are banding and spray sealing. During banding, a polymer band (e.g. gelatin or HPMC) is used to overlap between the body and cap of the capsule, while a hydroalcoholic solution is sprayed onto the cap's surface to stick the two segments together during spray sealing. Spray sealing requires special equipment and the process is very cost-intensive. Therefore, band sealing is more preferred for smaller scale productions.

The following non-limiting examples are presented to illustrate the invention.

### Example 1

### 1. Materials and Methods

Oregano extract (OreVida®, from FLAVEX) was monitored in different compositions during storage in order to study the influence of composition, capsule material and storage conditions on the chemical stability of the THQ and CRV contained in it. Photochemical degradations of THQ were prevented by using opaque/coloured capsules. The disintegration time of the capsules was also tested to gain information about possible interactions of THQ or CARV with the capsule shell leading to the formation of a water-insoluble complex, which might result in prolonged capsule disintegration.

### 1.1 Composition of Capsule Fill and Types of Capsule Shells

Since THQ is light-sensitive, the photodegradation was prevented by using opaque/coloured capsules, 00 in size which corresponds to a capsule volume of 0.91 mL. The above-mentioned capsule size and composition 1 (see in Table 1) are identical to those of the capsules used in the first human study described in WO 10/094761.

Previous studies showed that degradation of THQ could be prevented by diluting the extract or increasing its viscosity. Therefore, silicium dioxide (AEROSIL 200) or phosphatidylcholine (EPIKURON 135 F IP: fractionated soybean lecithin & soybean oil with enriched phosphatidylcholine content) were used as viscosity enhancers. The viscosity of the compositions is approx. 25 mPas at 25° C. without viscosity enhancer, while adding silicum dioxide or phosphatidylcholine increased viscosity up to 52-55 mPas (added amounts included in Table 1).

Middle chain triglycerides (MCT) were utilized as diluents. .

TABLE 1
Composition of capsule fills

| | | | | | Quant. | | |
|---|---|---|---|---|---|---|---|
| | | Lab.Cl | | | mg/Capsule | | |
| | | | mg/IU | Ovrg % | 1 | 2 | 3 |
| 1 | OréVida (Flavex: RV0402-17) | 60 | mg | 15 | 69.00 | 69.00 | 69.00 |
| 2 | Phosphatidylcholine | | | | 231.00 | | |
| 3 | Silicium dioxide | | | | | 4.00 | |
| 5 | Middle Chain Triglicerides (MCT) | | | | 420.00 | 647.00 | 651.00 |
| | Total fill weight | | | | 720.00 | 720.00 | 720.00 |

The compatibility of oregano extract was tested in hard gelatin capsules (Coni-Snap®), HPMC capsules (Vcaps®) and pullulan capsules (NPcaps™). Vcaps® and NPcaps™ are declared to be animal-free, preservative-free, gluten-free, non-GMO and GRAS. In addition, both hold Kosher and Halal certificates. All capsule brands were provided by Capsugel (Bornem, Belgium).

The compatibility of oregano extract was tested in hard gelatin capsules (Coni-Snap), HPMC capsules (Vcaps®) and pullulan capsules (NPcaps™). Vcaps® and NPcaps™ are declared to be animal-free, preservative-free, gluten-free, non-GMO and GRAS. In addition, both hold Kosher and Halal certificates. All capsule brands were provided by Capsugel (Bornem, Belgium).

The capsules prepared in this study were filled manually by using an Eppendorf micropipette, and capsule banding was done using conventional techniques. The sealed capsules were stored at room temperature, which lead to the solidification of gelatin via turning from the sol to the gel state.

### Example 2

### Capsule Disintegration

Disintegration time was measured by using a DISI-1 disintegration tester (Charles Ischi AG Pharma Prüftechnik, Zuchwill, Switzerland) in 900 ml demineralized water at 37° C. Six parallel measurements were carried out. The upper limit of disintegration time set in USP <2040> is 30 min for hard shell capsules.

### Example 3

### Stability Studies

A long term stability study was performed for 24 months. An accelerated stability study was performed for 6 months at 40° C./75% Relative Humidity (RH). Supporting data points were generated at 4° C. and 30° C. corresponding to the temperature conditions in refrigerator and to the storage conditions of the intermediate stability studies as set in the ICH guidelines. The retention of THQ and CARV was measured and monitored.

The quantification of carvacrol and thymoquinone was done by HPLC-UV. After an extraction with THF/methanol, CARV and THQ are analyzed by RP-HPLC-UV applying a gradient method. The detection wavelengths are set to 254 nm for THQ and 275 nm for CARV. Quantification was carried out by using external standard calibration. The initial assay and content uniformity determination were carried out by analyzing 10 capsules of each batch. Further for the stability, 2 capsules of each batch were analyzed at each time point.

### Stability of THQ and CARV in Liquid-Filled Hard Gelatin Capsules

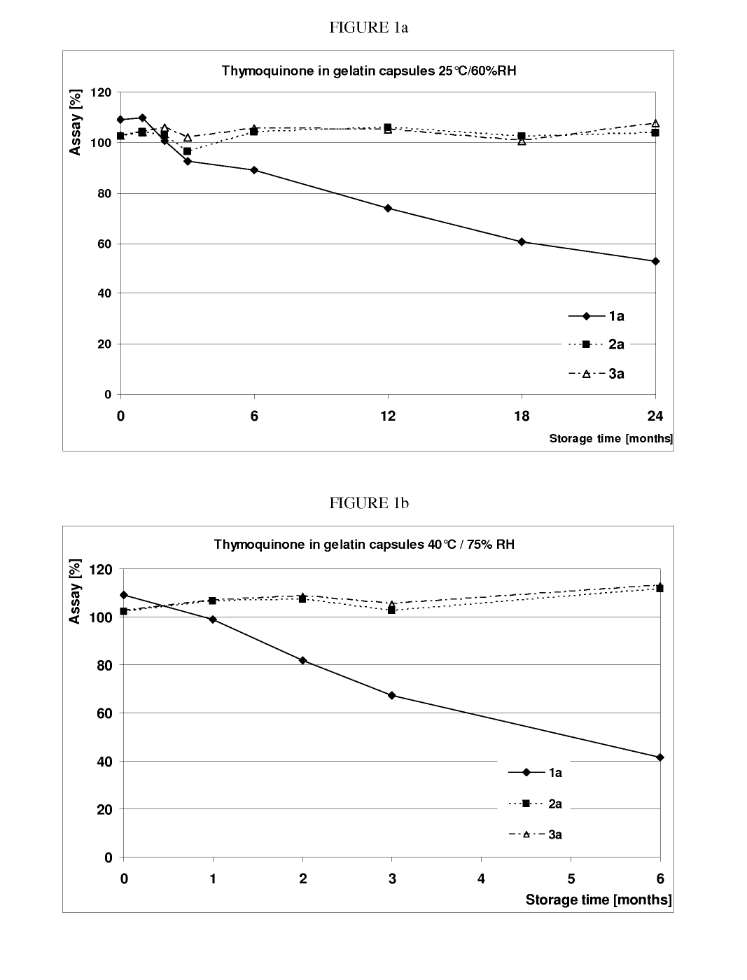

As shown in FIG. 1a and FIG. 1b, THQ shows a good stability in 2 of 3 compositions filled into hard gelatin capsules. A significant decrease in THQ content could already be observed in composition 1 after the first month of storage in the accelerated studies (40° C.). This finding was confirmed by the long-term stability results. As listed in Table 2, capsule formulations 1 contained phosphatidylcholine as a viscosity enhancer.

Our results show that that phosphatidylcholine is incompatible with oregano extract because it promotes chemical degradation of THQ during storage. Since composition 1 was stable during storage at 4° C., it is reasonable to assume that the undesired interaction of THQ with phosphatidylcholine can be prevented at low temperatures.

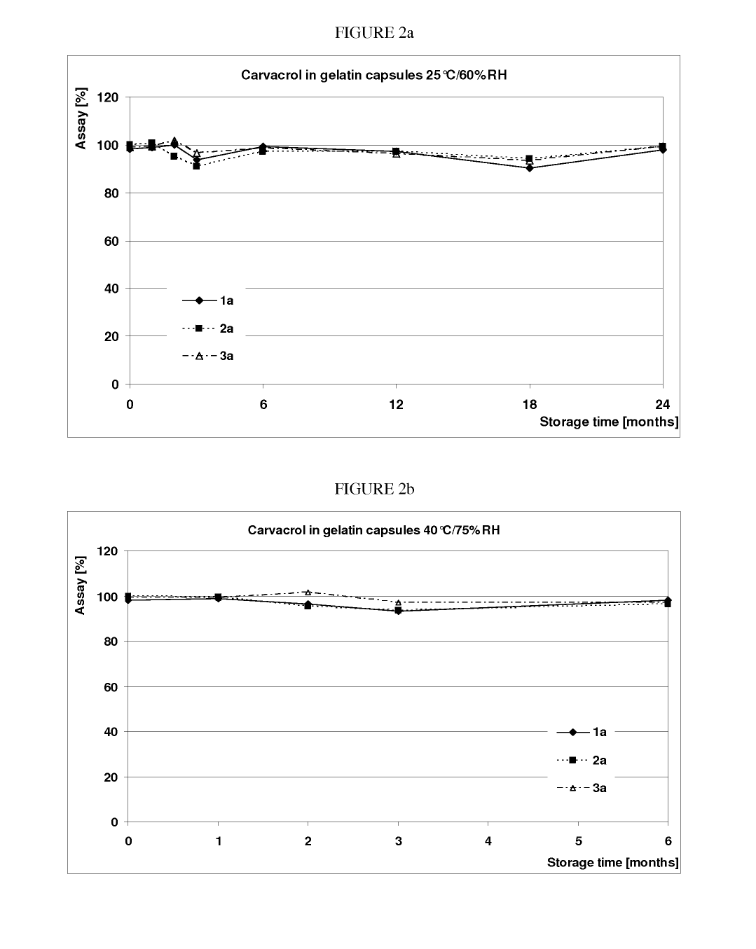

CAR was stable during storage in every capsule formulation (FIG. 2).

TABLE 2
Sample identification in stability studies (these numbers are referred to in
the FIGURES).

| | Capsule | | |
|---|---|---|---|
| | type | Viscosity enhancer | All fill components |
| 1a | Gelatin | Phosphatidylcholine | Orévida, Phosphatidylcholine, MCT |
| 2a | Gelatin | Aerosil | Orévida, Silicium dioxide, MCT |
| 3a | Gelatin | No | Orévida, MCT |
| 1b | HPMC | Phosphatidylcholine | Orévida, Phosphatidylcholine, MCT |
| 2b | HPMC | Aerosil | Orévida, Silicium dioxide, MCT |
| 3b | HPMC | No | Orévida, MCT |
| 1c | Pullulan | Phosphatidylcholine | Orévida, Phosphatidylcholine, MCT |
| 2c | Pullulan | Aerosil | Orévida, Silicium dioxide, MCT |
| 3c | Pullulan | No | Orévida, MCT |

### Stability of THQ and CRV in Liquid-Filled HPMC Capsules

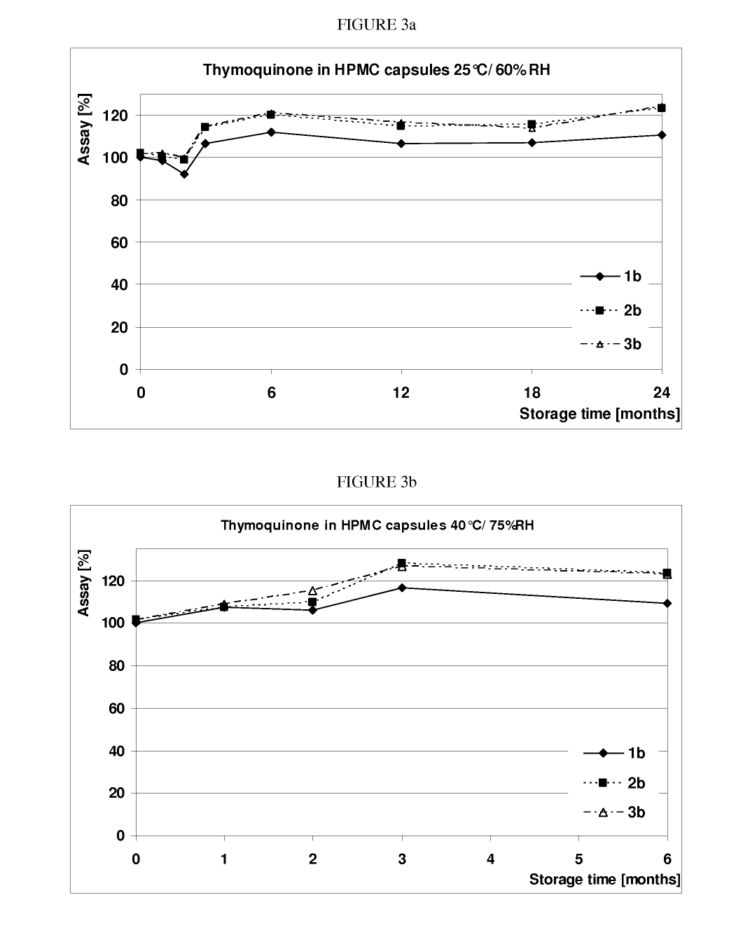

The stability of THQ in HPMC capsules during storage (25° C./60% RH & 40° C./75% RH) is shown in FIG. 3. An increasing THQ content could be measured for the capsule formulations filled into HPMC capsules, which seemed to reach equilibrium after 3 months of storage under accelerated conditions and after 6 months of storage at room temperature (FIG. 3).

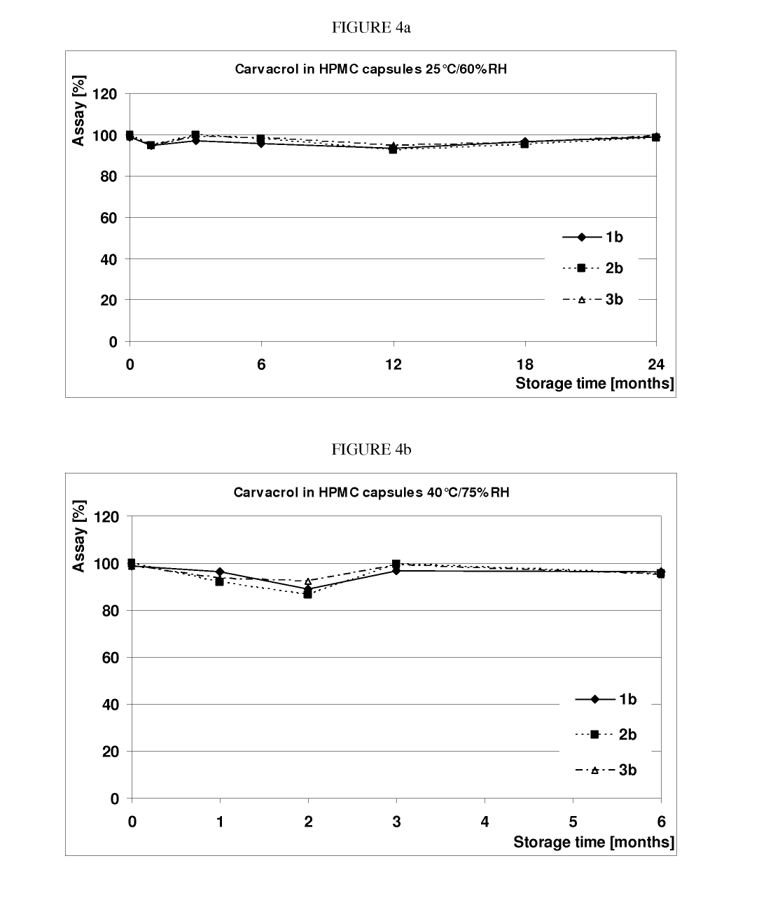

This phenomenon can be explained with the fact that the oxygen permeability of HPMC capsules is higher than those of the gelatin and the pullulan capsules. Since the oregano extract can be regarded as a multi-component mixture, while not wishing to be bound by theory, it appears that a minor component of the extract or small amounts of CRV could be converted to THQ via oxidation during storage. After reaching equilibrium, the chemical degradation of THQ became apparent in compositions 1 containing phosphatidylcholine. CRV showed good stability in HPMC capsules (FIG. 4).

### Stability of THQ and CRV in Liquid-Filled Pullulan Capsules

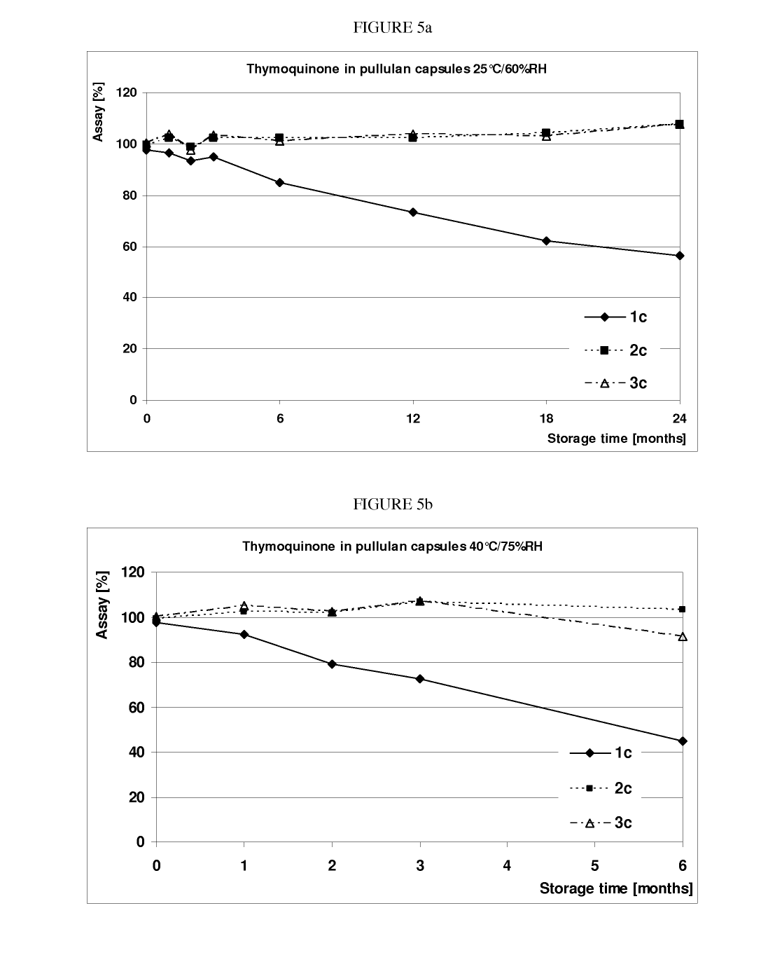

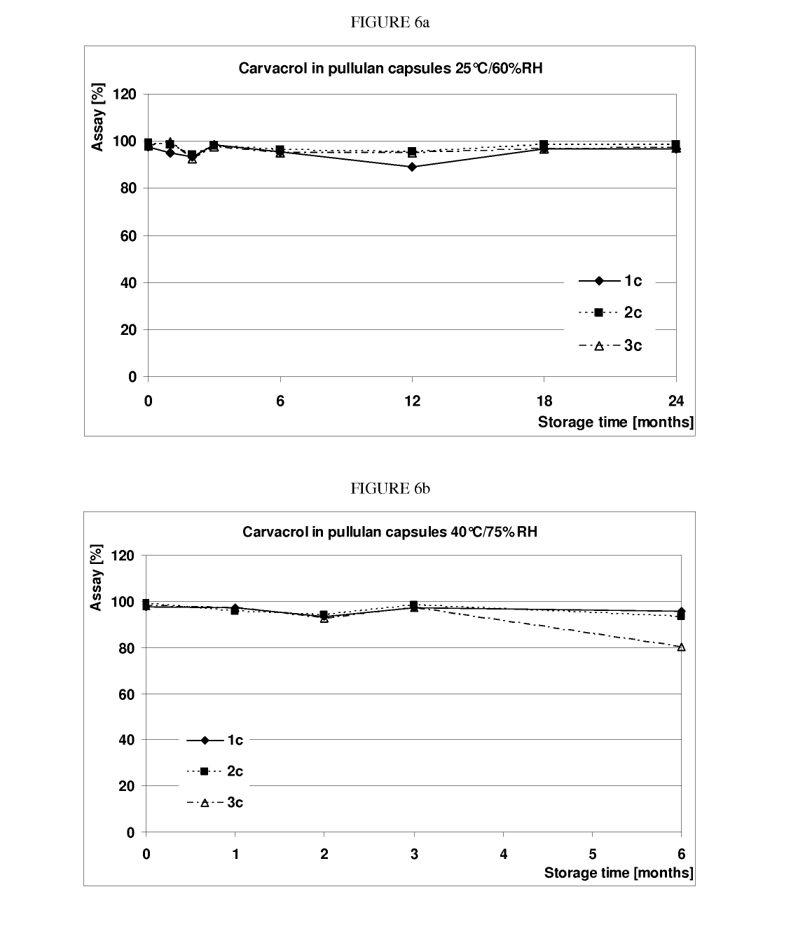

The stability results generated with oréVida in pullulan capsules are similar to those observed for gelatin capsules. The capsule composition containing phosphatidlycholine showed inferior stability also in pullulan capsules (FIG. 5). The lower CRV retention measured after 6 months of storage at 40° C. was not confirmed by the long term stability studies. CRV seems to be stable in pullulan capsules as well (FIG. 6).

On the basis of the stability data, it can be concluded that the capsule formulations, where oregano extract is mixed and diluted with certain excipients, show good stability in gelatin, HPMC and pullulan capsules, if they are formulated without phosphatidylcholine.

### Example 4

### Disintegration Time

The amino groups of gelatin (lysine residues) tend to cross-link with aldehydes with the passage of time and/or under accelerated stability conditions. Aldehydes are main constituents of essential oils, such as peppermint oil. HPMC is reported to interact with antioxidant polyphenolic actives frequently present in herbal extracts, such as green tea extract. These interactions result in prolonged capsule disintegration and, consequently, retard the rate and extent of dissolution.

In order to test the compatibility of oréVida with the capsule shells used in this study, disintegration time of the capsule formulations was measured in 900 ml distilled water at 37° C.

TABLE 3
Disintegration time of the capsules during storage at 25° C./60% RH

Disintegration time (min:s)

| | | | | |
|---|---|---|---|---|
| Sample | 0 | 12 M | 18 M | 24 M |

a, gelatin capsules

| | | | | |
|---|---|---|---|---|
| 1a | * | 07:22 | 06:32 | 06:35 |
| 2a | * | 08:06 | 08:12 | 09:48 |
| 3a | 04:55 | 06:21 | 06:05 | 06:53 |

b, HPMC capsules

| | | | | |
|---|---|---|---|---|
| 1b | 06:05 | 05:36 | 08:08 | 05:56 |
| 2b | 06:07 | 05:44 | 07:01 | 06:04 |
| 3b | 05:56 | 05:59 | 06:03 | 05:45 |

c, pullulan capsules

| | | | | |
|---|---|---|---|---|
| 1c | 03:48 | 07:09 | 04:19 | 05:12 |
| 2c | 03:14 | 04:35 | 03:00 | 03:27 |
| 3c | 02:08 | 02:36 | 03:08 | 02:29 |

As included in Table 3, no significant increase in disintegration time was observed for capsules stored at 25° C./60% RH.

It must be noted, that the oregano extract is strongly diluted in the fill compositions. The concentration of the extract is lower than 10 w/w % in relation to the total fill weight. Diluting the substances, which can potentially react with the capsule shell, might reduce probability of an undesired interaction.

What is claimed is:

1. A method of marketing a capsule comprising:
providing a kit, wherein the kit comprises a plurality of capsules in a capsule container, wherein each capsule comprises:
a) shell selected from the group consisting of: hydroxypropylmethylcellulose (HPMC), pullulan, and gelatin;
b) a fill composition comprising an oregano extract comprising at least 2 weight % thymoquinone (THQ),
c) a diluent selected from the group consisting of: middle chain triglycerides, glycerol, edible vegetable waxes; plant oils, and mixtures thereof; and
d) a viscosity increasing agent, with the proviso that the viscosity increasing agent is not phosphaditylcholine, and with the further proviso that when the shell is pullulan or gelatin, then the viscosity increasing agent comprises neither phosphatidylcholine nor lecithin; and
providing informational material which comprises informs a potential consumer about the benefits of a capsule containing oregano extract comprising thymoquinone.

2. A method according to claim 1 wherein the capsules contain from 2-8 weight % thymoquinone.

3. A method according to claim 1 wherein the plaint oil diluent is selected from the group consisting of olive oil, palm oils, sunflower oils, maize/corn oil, soybean oil, sesame oil, and rice bran oil.

4. A method according to claim 1 wherein the kit comprises informational material.

5. A method according to claim 1 wherein the informational material is not physically associated with the kit.

6. A method according to claim 1 wherein the informational material is in the form of printed leaflets, flyers, or advertising placards, which is displayed in the proximity of the kit.

7. A method according to claim 1 wherein the information is provided to the customer through mass communication advertising selected from the group consisting of television/radio advertising, print advertising, internet marketing and advertising, social network sites, and web sites.

8. A method according to claim 1 wherein the informational material conveys at least one benefit selected from the group consisting of the following benefits:
a) THQ can mask the taste of CRV,
b) THQ can boost mental processes,
c) THQ can interact with neurotransmitters,
d) THQ can act on mental processes by enhancing brain waves
e) the capsule provides the completeness of the oregano extract containing THQ,
f) the oregano is a natural renewable source of the oregano extract containing THQ,
g) the capsules provide a source of stable THQ
h) the capsules can be stored at room temperature without loss of THQ, and
i) oregano is an alternative source of THQ.

9. A method according to claim 1 wherein the capsules are opaque.
